(19) United States
(12) Patent Application Publication
(10) Pub. No.: US 2006/0064469 A1
(43) Pub. Date: Mar. 23, 2006

(54) System and method for URL filtering in a firewall

(75) Inventors: Jai Balasubrahmaniyan, Milpitas, CA (US); Kuntal Daftary, Milpitas, CA (US); Venkateswara Rao Yarlagadda, Bangalore (IN); Krishna Kumar, Bangalore (IN)

Correspondence Address: CARPENTER & KULAS, LLP, 1900 EMBARCADERO ROAD, SUITE 109, PALO ALTO, CA, 94303, US

(73) Assignee: Cisco Technology, Inc.

(21) Appl. No.: 10/948,474

(22) Filed: Sep. 23, 2004

(51) Int. Cl. G06F 15/16

(52) U.S. Cl. 709/218

(57) ABSTRACT

A method, system and a computer program product for managing requests for Uniform Resource Locators (URLs) in a firewall is provided. The firewall scans for requests for URLs and extracts the URLs from the requests. The firewall then checks for the URLs in an exclusive domains list. If the exclusive domains list allows the requested URLs, the firewall allows the URLs. In case the exclusive domains list disallows the requested URLs, the firewall blocks the requests for the URLs.

### BACKGROUND OF THE INVENTION

1. Field of Invention

The present invention relates in general to the field of computer networking. More specifically, embodiments of the present invention relate to systems and methods for the management of requests for Uniform Resource Locators (URLs) in computer networks.

2. Description of the Background Art

Many organizations use URL filtering software to prevent employees from accessing websites that are not relevant to their work or contain objectionable material. URL filtering involves blocking/allowing access to the site to which a URL points. Conventionally, URL filtering is performed at a firewall. After filtering, the request is sent to the server which hosts the website. On receiving a request for a URL from a requesting computer, the firewall sends the URL to a URL filtering server. The URL filtering server holds policies that define access rights for websites. In other words, rules that allow and deny access to websites, based on their URLs, are stored in the URL filtering server. On receiving the URL from the firewall, the URL filtering server checks the URL for the access rights and sends a response to the firewall. Based on the response, the firewall allows or denies the URL. If the URL is allowed by the URL filtering server, the firewall forwards the original request for the URL to a webserver, which responds with the contents of the website to which the URL points. If the URL is denied, the firewall sends an access denied webpage to the requesting computer.

The method for URL filtering, as described above, is process intensive as it involves processing at the firewall and the URL filtering server. Further, if the response from the URL filtering server is delayed, the requesting computer resends multiple requests for the URL. The method is not applicable for Virtual Private Networks (VPNs). VPNs are networks that use the Internet for communication between intranets of organizations, but are secure and cannot be accessed by computers that are not part of a VPN. Therefore, the access rights of each VPN have to be defined separately. In summary, the method of URL filtering is slow, wastes network resources and is not applicable to different types of networks.

### SUMMARY OF EMBODIMENTS OF THE INVENTION

Embodiments of the present invention provide a system for managing requests for URLs in a computer network. The system comprises a firewall, at least one URL filtering server and a webserver. The firewall comprises an exclusive domains list, which defines the filtering of URLs. In further embodiments, the firewall also includes an IP cache list for storing the responses from the URL filtering server. In further embodiments, the firewall also includes a response buffer for buffering the response of the webserver.

Embodiments of the present invention also provide a method for managing requests for URLs. Requests for URLs are scanned and the URLs are extracted from the requests. The URL is checked for in at least one exclusive domains list stored in a firewall. In case the exclusive domains list disallows the URL, the firewall blocks the URL. However, in case the exclusive domains list allows the URL, the URL is allowed.

Embodiments of the present invention also provide a method for controlling web access through a firewall comprising determining by a firewall that one of a plurality of URL filtering servers is not operable, and switching by the firewall to an operable URL filtering server.

Futher provided by embodiments of the present invention is a method for controlling web access of an organization comprising determining by a firewall if a URL filtering server is not operable. The method may additionally comprises denying all web access through the firewall after the determining by the firewall that the URL is not allowed, and allowing all web access through the firewall after said determining by the firewall that the URL is not allowed.

Further provided by embodiments of the present invention is an apparatus for filtering URL in a firewall comprising a processor and a machine-readable medium including instructions executable by the processor for: (i) sending through a firewall an HTTP request to a webserver, (ii) creating a URL request, (iii) sending the created URL request to a URL filtering server for determining if the URL request is acceptable or unacceptable, and (iv) buffering a response from the webserver until the URL filtering server determines if the URL is acceptable or unacceptable.

Embodiments of the present invention also provide an apparatus for storing a URL in a firewall comprising a processor, and a machine-readable medium including instructions executable by the processor for: (i) sending through a firewall an HTTP request to a webserver, (ii) creating a URL request, (iii) determining if the URL request is acceptable or unacceptable, and (iv) storing the URL acceptance or denial in the firewall.

Embodiments of the present invention also provide an apparatus for controlling web access through a firewall comprising a processor, and a machine-readable medium including instructions executable by the processor for: (i) determining by a firewall that one of a plurality of URL filtering servers is not operable, and (ii) switching by the firewall to an operable URL filtering server.

Embodiments of the present invention also provide an apparatus for controlling web access of an organization comprising a processor, a machine-readable medium including instructions executable by the processor for determining by a firewall if a URL filtering server is not operable.

Embodiments of the present invention also provide a system for filtering URL in a firewall comprising means for sending through a firewall an HTTP request to a webserver, means for creating a URL request, means for sending the created URL request to a URL filtering server for determining if the URL request is acceptable or unacceptable, and means for buffering a response from the webserver until the URL filtering server determines if the URL is acceptable or unacceptable.

Embodiments of the present invention also provide a system for storing a URL in a firewall comprising means for sending through a firewall an HTTP request to a webserver, means for creating a URL request, means for determining if the URL request is acceptable or unacceptable, and means for storing the URL acceptance or denial in the firewall.

Embodiments of the present invention also provide a system for controlling web access through a firewall comprising means for determining by a firewall that one of a plurality of URL filtering servers is not operable, and means for switching by the firewall to an operable URL filtering server.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a block diagram illustrating a computer network in which various embodiments of the present invention are practiced.

FIG. 2 is a block diagram illustrating the components of a firewall, in accordance with an exemplary embodiment of the present invention.

FIG. 3 is a block diagram illustrating an exemplary embodiment of the arrangement of URLs in an exclusive domains list.

FIG. 4 is a flowchart of a method for managing a request for a URL, in accordance with one embodiment of the present invention.

FIG. 5 illustrates an exemplary embodiment of an access denied page.

FIG. 6 is a flowchart of a method for managing a request for a URL, in accordance with another embodiment of the present invention.

FIG. 7 is a block diagram illustrating a system for filtering requests for URLs in a virtual network, in accordance with an exemplary embodiment of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in-detail to avoid obscuring aspects of embodiments of the present invention.

The present invention provides a method, a system and a computer program product for Uniform Resource Locator (URL) filtering in a computer network. URL filtering involves blocking/allowing access to the website to which a URL or a domain name points.

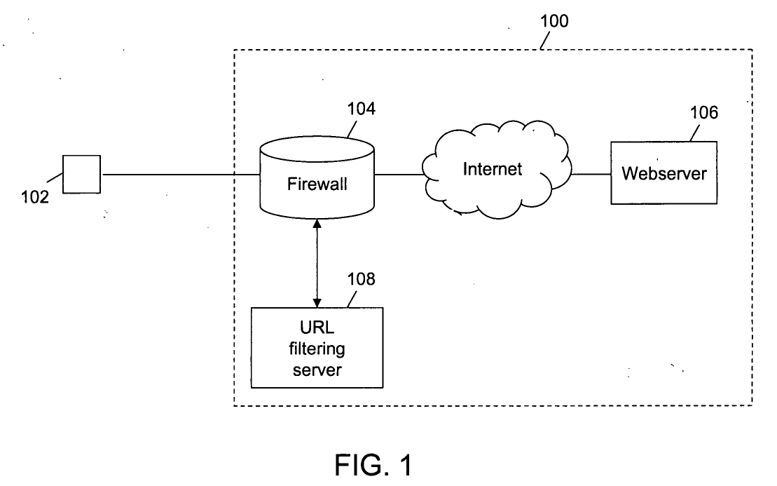

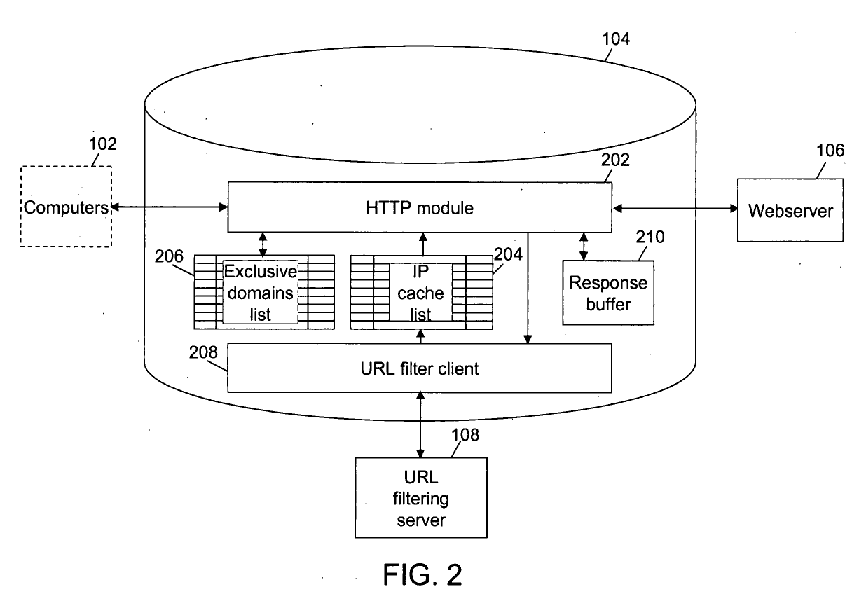

FIG. 1 is a block diagram illustrating a computer network in which the present invention is practiced. The computer network comprises a system 100 for managing requests for URLs and a plurality of computers 102. System 100 comprises a firewall 104, a webserver 106, and a URL filtering server 108. Computers 102 can be a part of an intranet. The computers within the intranet can be connected in topologies such as bus topologies, ring topologies or star topologies. Each computer 102 sends requests for URLs to firewall 104. For example, computer 102 can send a request for the URL ‘http://www.yahoo.com’. This means that computer 102 wants to view the website to which the URL points, i.e., the website of the Yahoo directory. Similarly, computer 102 can also request for other URLs, for example, ‘http://www.hotmail.com’. Firewall 104 filters the request for the URL and routes the request for the URL to a server that hosts the website requested by computer 102. In an embodiment of the present invention, firewall 104 is a part of a router. Examples for routers include the Cisco 7200, 7500, and 7600 Series routers. Firewall 104 can also be a computer running a firewall software. Firewall 104 sends the URL to URL filtering server 108 to check whether the URL is allowed or disallowed. URL filtering server 108 defines the filtering of the URL by storing access rights or rules for allowing or disallowing URLs. An exemplary URL filtering server is the Websense Server developed by Cisco Technology Inc. However, before sending the URL to URL filtering server 108, firewall 104 checks in an IP cache list stored on firewall 104 itself The IP cache list is explained later in conjunction with FIG. 2. The URL is also checked in an exclusive domains list, also stored in firewall 104. Exclusive domains list is explained later in conjunction with FIG. 2. If the URL is not found in the exclusive domains list and the IP cache list, firewall 104 sends the URL to URL filtering server 108. Firewall 104 also forwards the request for the URL to webserver 106, which obtains the contents of the website to which the URL points to from the server that hosts the website and sends the contents back to firewall 104. In case the URL is allowed, firewall 104 sends the contents to computer 102 that requested for the URL. In an embodiment of the invention, firewall 104 maintains a log of the requests for URLs received from all computers. A network administrator can use this log for identifying faults in the intranet from which firewall 104 receives requests.

FIG. 2 is a block diagram illustrating the components of firewall 104 in an exemplary embodiment of the invention. Firewall 104 comprises a HyperText Transfer Protocol (HTTP) module 202, an IP cache list 204, at least one exclusive domains list 206, a URL filter client 208, and a response buffer 210. HTTP module 202 scans for requests for URLs. In various embodiments of the invention, the request can be an HTTP request. When it receives a request for a URL, HTTP module 202 extracts the URL from the request. IP cache list 204 comprises recent responses received from URL filtering server 108. URLs stored in IP cache list 204 are not sent to URL filtering server 108. Exclusive domains list 206 comprises commonly requested URLs and their access rights. URLs present in exclusive domains list 206 are also not sent to URL filtering server 108. URL filtering client 208 sends URLs not present in exclusive domains list 206 and IP cache list 204 to URL filtering server 108. In one embodiment of the present invention, URL filtering client 208 connects to URL filtering server 108 through a persistent Transmission Control Protocol (TCP) connection. URL filtering client 208 can connect to URL filtering server 108 through other connections such as a User Datagram Protocol (UDP) connection. Responses from URL filtering server 108 are received by URL filtering client 208. These responses are stored in IP cache list 204 and sent to HTTP module 202. Response buffer 210 receives contents of the website from webserver 106 and buffers them, so that HTTP module 202 can send the buffered contents to computer 102, when URL filtering server 108 allows the URL.

Exclusive domains list 206 comprises access rights for commonly requested URLs. These URLs are often requested by computers from firewall 104. In an exemplary embodiment of the present invention, these URLs are decided based on a statistical analysis of the requests from the computers in a predefined period of time, for example, in a month. Further, a network administrator can modify exclusive domains list 206 to include specific URLs. Examples of URLs present in exclusive domains list 206 include URLs for important information sources, for popular e-mail providers and for search engines. An organization can also allow the URL for its own website. Similarly, exclusive domains list 206 can disallow access to websites that contain objectionable material. Further, exclusive domains list 206 can comprise complete and partial domain names. An example for a complete domain name is ‘www.yahoo.com’. If exclusive domains list 206 disallows ‘www.yahoo.com’, then computers cannot access the Yahoo website and also pages that are part of the same domain name, for example ‘www.yahoo.com/news’ and ‘www.yahoo.com/mail’. An example for a partial domain name is ‘.cisco.com’. If exclusive domains list 206 allows ‘cisco.com’, then computers can access the Cisco website, i.e., ‘www.cisco.com’ and also other websites that are part of the Cisco domain name, for example ‘www.cisco.com/products’ and ‘www.cisco.com/services’. Further, URLs that are variants of the partial domain name are also allowed. Therefore, computers can also access, for example, ‘people.cisco.com’ and ‘newsroom.cisco.com’.

In accordance with one embodiment of the present invention, IP cache list 204 and exclusive domains list 206 are stored in Non-Volatile Random Access Memories (NVRAMs). IP cache list 204 and exclusive domains list 206 can also be stored in other forms of storage, such as compact flash cards or hard disk drives.

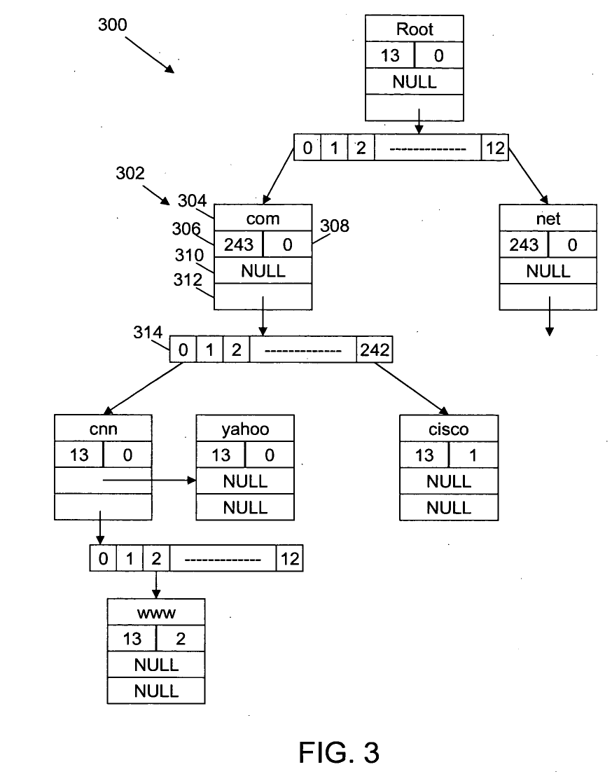

FIG. 3 is a block diagram illustrating an exemplary embodiment of the arrangement of URLs in exclusive domains list 206. URLs are fragmented with respect to the periods (i.e., ‘.’) in the URLs. Further, the fragmented URLs are stored with the help of hash tables in a tree 300. Each node in tree 300 comprises elements including a pointer to a child hash table, a pointer to a sibling node, size of the child hash table, access rights for URLs, and a flag to indicate the end of a domain. For example, a node 302 corresponds to all URLs that end with ‘.com’. This is stored in an element 304. An element 306 stores the size of a child hash table 314. A value of 242 indicates that node 302 has 243 child nodes. An element 308 defines access rights for URLs. A value of 0 indicates that the access rights are stored in a child node as the URL is not complete. A value of 1 indicates that a URL is allowed. Finally, a value of 2 indicates that a URL is not allowed. Therefore, all websites that are part of ‘www.yahoo.com’ and ‘www.cnn.com’ are blocked. All websites that are part of ‘cisco.com’ and its variants such as ‘people.cisco.com’ are allowed. An element 310 stores a pointer to a sibling node. For example, the node corresponding to ‘cnn.com’ comprises a pointer to the node corresponding to ‘yahoo.com’ as the access rights for both are similar. Further, an element 312 stores a pointer to child hash table 314. Child hash table 314 comprises pointers to all child nodes of node 302.

In one embodiment of the present invention, URLs in IP cache list 204 are stored as a hash table. In the hash table, URL's are divided into categories or buckets that are substantially of equal size. Usage of a hash table for storing URLs reduces the time for searching for a URL in IP cache list 204. In another embodiment, URLs in IP cache list 204 and exclusive domain list 206 are stored in an array.

The time taken in searching for a URL in exclusive domains list 206 or IP cache list 204 is dependent on the number of URLs in exclusive domains list 206 or IP cache list 204. Therefore, in an exemplary embodiment of the present invention, the number of URLs in exclusive domains list 206 and IP cache list 204 is restricted to 5000 each.

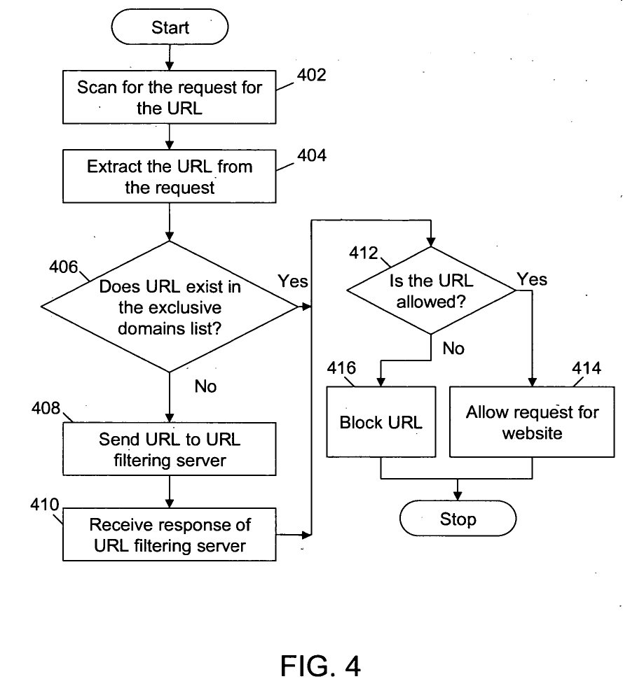

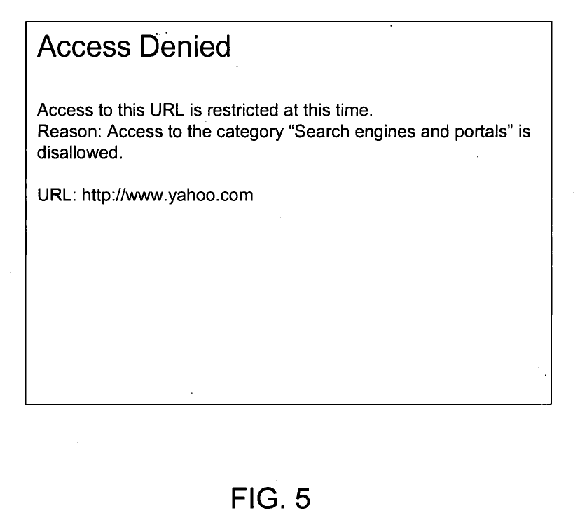

FIG. 4 is a flowchart of a method for managing a request for a URL, in accordance with one embodiment of the present invention. At step 402, HTTP module 202 scans for a request for a URL. A request is part of data that is sent by computer 102. On detecting the request, HTTP module 202 extracts the URL from the request at step 404. At step 406, HTTP module 202 checks whether the URL is present in exclusive domains list 206. If the URL is found in exclusive domains list 206, then step 412 is performed. If the URL is not found in exclusive domains list, HTTP module 202 sends the URL to URL filtering server 108 at step 408 through URL filtering client 208. URL filtering client 208 then waits for the response of URL filtering server 108. At step 410, URL filtering client 208 receives the response of URL filtering server 108. The response comprises the URL and the access rights for the URL. At step 412, HTTP module 202 checks whether the URL is allowed or disallowed. HTTP module 202 decides whether the URL is allowed or disallowed on the basis of the contents of exclusive domains list 206 or the response of URL filtering server 108. If the URL is allowed, HTTP module 202 allows the request for the website at step 414. This means that HTTP module 202 forwards the request for the URL to webserver 106. Further, HTTP module receives the response of webserver 106 and sends the response to computer 102. The response of webserver 106 comprises the contents of the website to which the requested URL points. In case the URL is not allowed, HTTP module 202 blocks the URL at step 416. Further, HTTP module 202 sends an access denied page to computer 102. In one embodiment of the invention, the access denied page informs computer 102 about the reason for disallowing the website. FIG. 5 illustrates an exemplary embodiment of an access denied page.

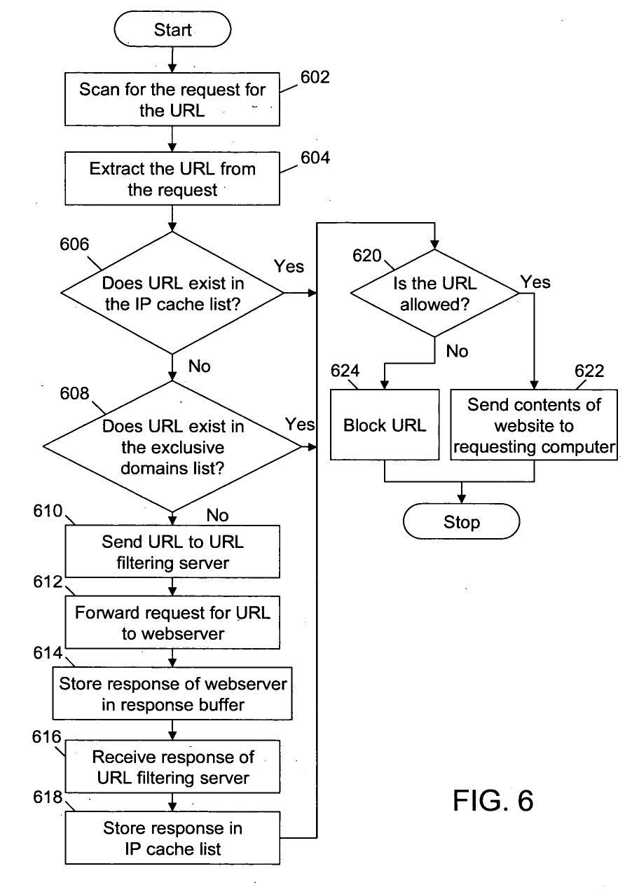

FIG. 6 is a flowchart illustrating the steps for managing a request for a URL, in accordance with another embodiment of the present invention. At step 602, HTTP module 202 scans for a request for a URL. The request is part of data that is sent by computer 102. On detecting the request, HTTP module 202 extracts the URL from the request at step 604. At step 606, HTTP module 202 checks whether the URL is present in IP cache list 204. If the URL is present, then step 620 is performed. If the URL is not present in IP cache list 204, HTTP module checks whether the URL is present in exclusive domains list 206 at step 608. If the URL is present in exclusive domains list 206, then step 620 is performed. If the URL is not found in exclusive domains list also, HTTP module 202 sends the URL to URL filtering server 108 at step 610 through URL filtering client 208. In one embodiment of the invention, URL filtering client 208 also sends the IP address of computer 102 or the username of the user of computer 102, along with the URL. The IP address is used for authentication purposes, which is explained later. In accordance with another embodiment of the invention, while URL filtering client 208 waits for the response of URL filtering server 108, HTTP module forwards the request for the URL to webserver 106 at step 612. If the response of webserver 106 arrives before the response from URL filtering server 108, then HTTP module 202 stores the response in response buffer 210 at step 614. The response of webserver 106 comprises contents of the website requested by computer 102. If the response of URL filtering server 108 is received before the response of webserver 106, then HTTP module does not store the response of webserver 106 in response buffer 210. At step 616, URL filtering client 208 receives the response of URL filtering server 108. The response comprises the URL and the access rights for the URL. URL filtering client 208 stores the response in IP cache list 204 at step 618.

At step 620, HTTP module 202 checks whether the URL is allowed or not. HTTP module 202 decides whether the URL is allowed or disallowed on the basis of the contents of IP cache list 204, exclusive domains list 206 or the response of URL filtering server 108. If the URL is allowed, HTTP module 202 sends the contents of the website to which the URL points, to computer 102 at step 622. In case the URL is not allowed, HTTP module 202 blocks the URL at step 624. This means that the buffered contents of the website stored in response buffer 210 are removed. In case the contents of the website are not received from webserver 106, HTTP module 202 closes the connection to webserver 106. Webserver 106 then rejects the contents of the website when they arrive. Further, HTTP module 202 sends an access denied page, as shown in FIG. 5, to computer 102.

In accordance with another embodiment of the present invention, system 100 further comprises a plurality of secondary URL filtering servers. Plurality of secondary URL filtering servers enables controlling of web access in, for example an organization, through firewall 104. In case, URL filtering client 208 determines that URL filtering server 108 is not operable, URL filtering client 208 sends the URL to a secondary URL filtering server. URL filtering server 108 is inoperable if, for example, the TCP connection between URL filtering server 108 and URL filtering client 208 is disconnected. Secondary URL filtering servers ensure that even when URL filtering server 108 is inaccessible, requests for URLs are served. In case no response is received from the secondary URL filtering server, URL filtering client 208 sends the URL to another secondary URL filtering server. Further, in case none of the secondary URL filtering servers send a response to URL filtering client 208, system 100 serves the request for the URL based on an ‘allow mode’. If the allow mode is set to ‘on’ and no response is received from any URL filtering server, then all requests for URLs are served. In case the ‘allow mode’ is set to ‘off’ and no response is received from any URL filtering server, then all requests for URLs are disallowed. In this case, the access denied page informs computer 102 that no URL filtering server is active, and hence, all requests are disallowed.

Access rights for URLs can be defined on the basis of the users within an organization. For example, an organization may wish to disallow its employees to visit the website of a competitor organization. However, the management of the organization may want to view the website to identify the research interests of the competitor. In this case, access rights to the URL for the website have to be different for the users. As mentioned earlier, URL filtering client 208 sends the IP address of computer 102 or the username of the user of computer 102 to URL filtering server 108. In an exemplary embodiment of the present invention, URL filtering server 108 stores access rights for URLs based on user permissions. URL filtering server 108 decides whether computer 102 (or the user of computer 102) is allowed to view the requested website or not. This system for allowing access to websites based on user permissions can be implemented with the help of user authentication systems and protocols, such as NT LanMan system (NTLM), Lightweight Directory Access Protocol (LDAP), Terminal Access Controller Access Control System (TACACS), and Remote Access Dial-In User Service (RADIUS).

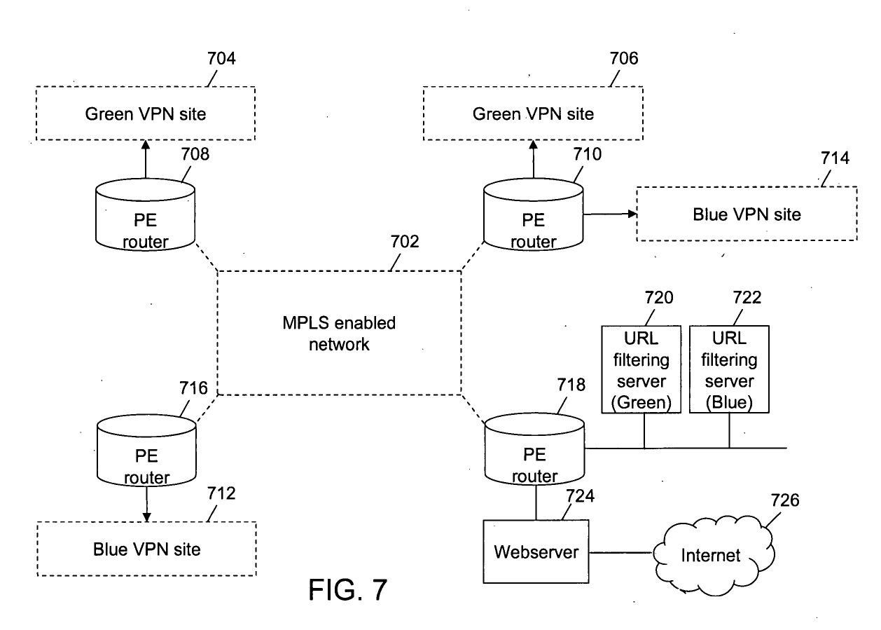

FIG. 7 is a block diagram illustrating a system for filtering requests for URLs in a virtual network, in accordance with an embodiment of the present invention. An exemplary virtual network is a MultiProtocol Label Switching (MPLS) enabled network. MPLS is a protocol that is used in routing Internet Protocol (IP) data packets based on labels. In an MPLS network, each router appends labels to IP data packets. Further, routers route IP data packets based on the labels, instead of the headers of the IP data packets. MPLS allows the creation of a plurality of Virtual Private Networks (VPN) within a network. VPNs are networks that use the Internet for communication between intranets of organizations, but are secure and cannot be accessed by computers that are not part of a VPN. As the VPNs are created in a single network, the VPNs are scaleable and further VPNs can be added without addition of hardware components.

VPNs use routing and forwarding tables to route IP data packets between the various computers that are a part of the VPNs. These tables also support routing and forwarding IP data packets to and from the Internet. Routing and forwarding IP data packets in VPNs with the help of routing and forwarding tables is known as VPN routing and forwarding (VRF). VRF tables are stored at Provider Edge (PE) routers. These routers act as interfaces between VPNs and MPLS networks of network services providers.

As shown in FIG. 7, a green VPN and a blue VPN are connected to an MPLS enabled network 702. These VPNs need not be located at one site. Therefore, two sites for each VPN are shown. Green VPN sites 704 and 706 connect to MPLS enabled network 702 through PE routers 708 and 710 respectively. Similarly, blue VPN sites 712 and 714 connect to MPLS enabled network 702 through PE routers 716 and 710 respectively. Other VPN sites can also connect to MPLS enabled network 702 through PE routers 708, 710, and 716. PE routers 708, 710, and 716 route and forward packets between the VPN sites. These routers also route and forward packets between the VPN sites and Internet 726, through a PE router 718. PE routers 708, 710, and 716 also help in filtering requests for URLs. PE routers 708, 710, and 716 include firewalls that are similar in structure and function to firewall 104 as illustrated in FIG. 4. PE routers 708, 710, and 716 have an exclusive domains list for each of the VPN sites to which they are connected. Therefore, PE router 716 has two exclusive domains lists, one each for the green VPN and the blue VPN. In another embodiment of the present invention, the PE routers store one exclusive domains list only. The exclusive domains list stores the access rights for URLs and the VPNs for which the access rights are valid. For example, when a computer in blue VPN site 714 sends a request for a URL, PE router 710 checks whether the URL is allowed or disallowed by carrying out the steps as described with the help of FIG. 4. However, while checking in the exclusive domains list, PE router 710 also checks whether the URL is allowed or disallowed for the blue VPN. In case the exclusive domains list disallows the URL only for the green VPN, PE router 710 allows the URL as the requesting computer is in the blue VPN. In case the URL is not found in the exclusive domains list or the IP cache list, PE router 710 sends the URL to a URL filtering server 722. In case the requesting computer is in green VPN site 706, then PE router 710 sends the URL to a URL filtering server 720. URL filtering servers 720 and 722 store access rights for URLs for the green VPN and the blue VPN respectively. URL filtering servers 720 and 722 have functionalities similar to URL filtering server 108. If a URL is allowed, PE router 710 forwards the request for the URL to a webserver 724 which obtains the contents of the website to which the URL points from Internet 726. In case the URL is blocked, PE router 710 sends an access denied page to the requesting computer.

The present invention offers many advantages. Presence of an exclusive domains list and an IP cache list reduces the involvement of URL filtering servers while filtering URLs. This reduces the amount of processing. Further, as access rights for a URL are obtained at the firewall itself, the time for filtering is reduced. Finally, multiple requests for URLs, due to network delays, are reduced.

Although the invention has been discussed with respect to specific embodiments thereof, these embodiments are merely illustrative, and not restrictive, of the invention. For example, firewall 104 can be embodied in any computing device such as a router to manage the request for URLs.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A “computer” for purposes of embodiments of the present invention may include any processor-containing device, such as a mainframe computer, personal computer, laptop, notebook, microcomputer, server, personal data manager or “PIM” (also referred to as a personal information manager or “PIM”) smart cellular or other phone, so-called smart card, set-top box, or any of the like. A “computer program” may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A “computer-readable medium” for purposes of embodiments of the present invention may be any medium that can contain, store, communicate, propagate, or transport the computer program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for managing a request for a Uniform Resource Locator (URL) in a firewall comprising:
scanning for the request;
extracting the URL from the request;
checking for access rights for the URL in an exclusive domains list stored in the firewall;
blocking the URL if the exclusive domains list disallows the URL; and
allowing the URL if the exclusive domains list allows the URL.

2. The method of claim 1 further comprising:
sending the URL to at least one URL filtering server; and
determining if the request for the URL is allowed or disallowed.

3. The method of claim 2 further comprising:
adding the response of the URL filtering server to an IP cache list.

4. The method of claim 2 further comprising:
requesting a webserver for the URL; and
buffering the response of the webserver till the URL filtering server determines if the URL is allowed or disallowed.

5. The method of claim 4 further comprising:
determining by the URL filtering server that the URL is disallowed;
removing the buffered response of the webserver; and
sending an access denied page to the requesting computer.

6. The method of claim 5 further comprising closing a connection between the requesting computer and the webserver that carries the request for the URL.

7. The method of claim 4 further comprising:
determining by the URL filtering server that the URL is allowed;
sending the buffered response of the webserver to the requesting computer.

8. The method of claim 7 wherein the sending the buffered response of the webserver to the requesting computer comprises sending by the firewall the buffered response of the webserver to the requesting computer.

9. The method of claim 2 further comprising:
determining if the URL filtering server is not operable; and
sending the URL to a secondary URL filtering server.

10. The method of claim 1 further comprising:
checking for access rights for the URL in an IP cache list stored in the firewall;
blocking the URL if the IP cache list disallows the URL; and
allowing the URL if the IP cache list allows the URL.

11. The method of claim 1 wherein the exclusive domains list comprises at least one of complete domain names and partial domain names.

12. A method for managing a request for a Uniform Resource Locator (URL) in a network, the network comprising at least one virtual network and at least one firewall, the method comprising:
providing at least one exclusive domain list corresponding to each virtual network in the at least one firewall;
scanning for the request;
extracting the URL from the request;
checking for access rights for the URL in the at least one exclusive domains list;
blocking the URL if the at least one exclusive domains list disallows the URL; and
allowing the URL if the at least one exclusive domains list allows the URL.

13. The method of claim 12 further comprising:
sending the URL to at least one URL filtering server; and
determining if the request for the URL is allowed or disallowed.

14. The method of claim 13 further comprising:
adding the response of the URL filtering server to an IP cache list.

15. The method of claim 13 further comprising:
requesting a webserver for the URL; and
buffering the response of the webserver till the URL filtering server determines if the URL is allowed or disallowed.

16. The method of claim 12 further comprising:
checking for access rights for the URL in an IP cache list stored in the firewall;
blocking the URL if the IP cache list disallows the URL; and
allowing the URL if the IP cache list allows the URL.

17. The method of claim 12 wherein the exclusive domains list comprises at least one of complete domain names and partial domain names.

18. A method for filtering URL in a firewall comprising:
sending through a firewall an HTTP request to a webserver;
creating a URL request;
sending the created URL request to a URL filtering server for determining if the URL request is acceptable or unacceptable; and
buffering a response from the webserver until the URL filtering server determines if the URL is acceptable or unacceptable.

19. A method for storing a URL in a firewall comprising:
sending through a firewall an HTTP request to a webserver;
creating a URL request;
determining if the URL request is acceptable or unacceptable; and
storing the URL acceptance or denial in the firewall.

20. A firewall for managing a request for a Uniform Resource Locator (URL) comprising:
a Hyper Text Transfer Protocol (HTTP) module for scanning the request and extracting the URL; and
at least one exclusive domains list for filtering the URL, the exclusive domains list storing access rights for URLs.

21. The firewall of claim 20 further comprising:
a URL filtering client for sending the URL to at least one URL filtering server; and
an IP cache list for storing responses of the at least one URL filtering server.

22. A system for managing a request for a Uniform Resource Locator (URL) comprising:
a firewall for filtering the request for the URL, the firewall further comprising at least one exclusive domains list for filtering the request for the URL, the exclusive domains list storing access rights for URLs;
at least one URL filtering server for defining the filtering of the URL; and
a webserver for serving the request for the URL.

23. An apparatus for managing a request for a Uniform Resource Locator (URL) in a firewall comprising:
a processor;
a machine-readable medium including instructions executable by the processor for:
scanning for the request;
extracting the URL from the request; and
blocking the URL if the exclusive domains list disallows the URL; and
allowing the URL if the exclusive domains list allows the URL.

24. A machine-readable medium in a firewall having stored thereon instructions for:
scanning for a request for a Uniform Resource Locator (URL);
extracting the URL from the request; and
blocking the URL if the exclusive domains list disallows the URL; and
allowing the URL if the exclusive domains list allows the URL.

25. A system for managing a request for a Uniform Resource Locator (URL) in a firewall comprising:
means for scanning for a request for a Uniform Resource Locator (URL);
means for extracting the URL from the request; and
means for blocking the URL if the exclusive domains list disallows the URL; and
means for allowing the URL if the exclusive domains list allows the URL.
